(19) United States
(12) Patent Application Publication
(10) Pub. No.: US 2011/0038464 A1
(43) Pub. Date: Feb. 17, 2011

(54) X-RAY RADIATOR

(76) Inventor: Joerg Freudenberger, Kalchreuth (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/855,180

(22) Filed: Aug. 12, 2010

(30) Foreign Application Priority Data
Aug. 17, 2009 (DE) 10 2009 037 724.7

(51) Int. Cl. H01J 35/12

(52) U.S. Cl. 378/141

(57) ABSTRACT

An x-ray radiator has an x-ray tube with a vacuum housing arranged in a radiator housing in which a coolant circulates. The vacuum housing has a porous coating, at least at parts thereof, on surfaces facing the coolant. The heat transfer between the vacuum housing and the coolant is thereby improved, such that the x-ray radiator can be more highly thermally loaded.

### BACKGROUND OF THE INVENTION

1. Field of the Invention

The invention concerns an x-ray radiator of the type having an x-ray tube that has a vacuum housing arranged in a radiator housing in which a coolant circulates.

2. Description of the Prior Art

An x-ray radiator of the above type has a radiator housing in which the x-ray tube is arranged so as to be rigid (stationary or fixed anode x-ray tube, or rotating anode x-ray tube) or rotatable (rotating piston x-ray tube).

In the x-ray tube, electrons are thermally generated by an x-ray source (filament, surface emitter) and accelerated toward an anode (stationary anode or rotating anode). Upon impact of the electrons on the anode, usable x-ray radiation is generated that exits the vacuum housing through an x-ray exit window. In the generation of the usable x-ray radiation, more than 99% of the energy that is used is converted into heat. This heat must be effectively dissipated by a cooling system during the operation of the x-ray tube. For this purpose, a coolant (water, oil) circulates in the radiator housing, this coolant flowing around the vacuum housing at its exterior, i.e. the surfaces thereof facing toward the coolant.

The vacuum housing of the x-ray tube also includes the necessary x-ray exit window, and possibly an internal cooling tube of a slide bearing of the x-ray tube and possibly an electron trap cooling surface.

Some applications require an optimally compact x-ray radiator design. Particularly in the case of unipolar x-ray tubes, the x-ray tube can be even further reduced in size due to the fact that insulating spacings between modules conducting high voltage are not necessary. In all cases, heat accumulates at particularly small contact surfaces with the cooling system. For example, the targeted dissipation of the heat generated in the anode ensues in an internal cooling tube of the slide bearing (stationary part of the slide bearing). As an alternative or in addition to a heat dissipation at the internal cooling tube of the slide bearing, a targeted heat dissipation can ensue at additional parts of the vacuum housing, for example at a cooling surface of an electron trap or at the x-ray exit window. The shrinking of the structural size in these components is limited by the previously achievable heat transfer coefficients at the cooling surfaces.

The surfaces facing the coolant have conventionally been either smooth, macroscopically structured (“ridges”) or sand-blasted, so an enlargement of the cooling surface is achieved but not an increase of the heat transfer coefficients. Such measures are described in DE 10 2004 003 370 A1 (for example) for a high-power anode plate for a directly cooled rotating piston tube.

### SUMMARY OF THE INVENTION

An object of the present invention to provide an x-ray radiator that can be thermally highly loaded, even given a compact structural shape.

The x-ray radiator according to the invention has an x-ray tube that has a vacuum housing arranged in a radiator housing in which a coolant circulates. According to the invention, the vacuum housing has a porous coating, at least in parts thereof, on its surfaces facing the coolant. The boundary surface between the coolant and the surfaces facing the coolant (outer surface of the vacuum housing) that is used for the heat transfer is thereby increased without bubbles (which form given a partial vaporization of the coolant) rapidly hindering or completely interrupting the flow of heat. The heat transfer between the outer surfaces of the vacuum housing and the circulating coolant is thus improved, in particular given nucleate boiling.

The heat transfer coefficient, and therefore the heat transfer from the heated vacuum housing to the circulating coolant, are improved via the at least partial porous coating (according to the invention) of the vacuum housing at its surfaces that are facing towards the coolant.

Within the scope of preferred embodiments of the x-ray radiator according to the invention, the vacuum housing can be provided completely or only partially with the porous coating on its surfaces facing the coolant. Preferred regions of the vacuum housing for a partial porous coating are, for example, the x-ray exit window; the internal slide bearing cooling tube, the electron trap cooling surface and the back side of the anode. In the aforementioned regions, an increased temperature of the vacuum housing occurs (in particular given an x-ray radiator of compact design) that can be dissipated markedly better by the coolant circulating in the radiator housing via an at least partial porous coating.

The porous coating can, for example, be applied on the outer surfaces of the vacuum housing by means of a sintering method.

The layer thickness of the porous coating advantageously amounts to approximately 30 μm to approximately 200 μm.

Metals—in particular stainless steel, copper (very good head conduction) and/or titanium (no unwanted influencing of the spectrum of the x-ray radiation)—are advantageously provided as corrosion-resistant materials for the at least partial porous coating.

### BRIEF DESCRIPTION OF THE DRAWINGS

FIG. 1 shows a vacuum housing of an x-ray tube of an x-ray radiator in a region of an x-ray exit window.

FIG. 2 shows the basic relationship upon boiling of a liquid coolant using a characteristic boiling curve.

### DESCRIPTION OF THE PREFERRED EMBODIMENTS

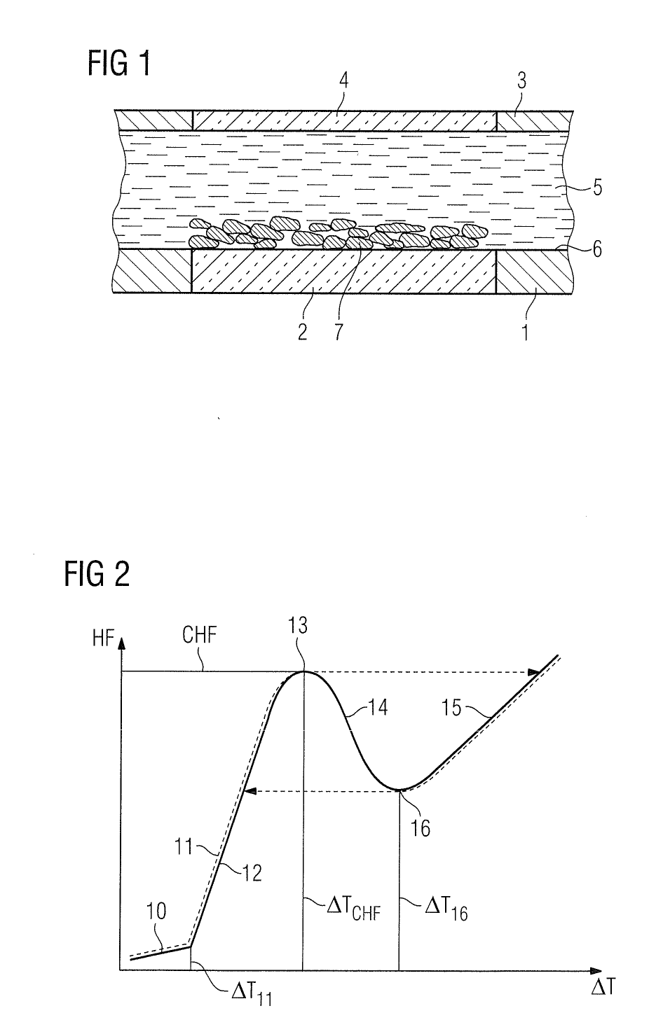

A vacuum housing of an x-ray tube is designated with 1 in FIG. 1. T x-ray tube has an x-ray exit window 2. The vacuum housing of the x-ray tube is arranged in a radiator housing 3 that has a beam exit window 4 aligned with the x-ray exit window 2. A coolant 5 (water, oil) circulates in the radiator housing 3. The coolant 5 discharges the heat created in the generation of the usable x-ray radiation. According to the invention, the vacuum housing 1 is at least partially covered by porous coating 7 on its surfaces 6 facing the coolant 5.

It is not important whether the surfaces 6 facing the coolant 5 (outer surfaces of the vacuum housing 1) are geometrically structured in order to provide a larger surface area for heat transfer, such as by having ridges, cooling fins or the like that are also provided with the porous coating 7.

In the shown exemplary embodiment, the porous coating 7 is applied to the x-ray exit window 2. The porous coating 7 on the x-ray exit window 2 consists of titanium since this material does not undesirably affect the spectrum of the x-ray radiation.

Within the scope of the invention it is also possible for additional surfaces of the vacuum housing 1 that face towards the coolant 5 to be provided (not shown in FIG. 1) with a porous coating. For example, all surfaces of the vacuum housing 1 that face the coolant 5 (outer surfaces of the vacuum housing 1) can have a porous coating.

This porous coating does not necessarily need to be executed identically at every location. It can be advantageous to use different materials and/or different layer thicknesses—advantageously between 30 μm and 200 μm for the porous coating at different locations. For example, as noted above, titanium may be used (only) for the porous coating 7 of the x-ray exit window 2 and copper, due to its good heat conductivity, may be used as a material for the outer surfaces of the vacuum housing 1 that lie outside of the x-ray exit window 2. Furthermore, it can be advantageous to apply porous coatings with a larger layer thickness for outer surfaces—for example the surface of an internal slide bearing cooling tube, the electron trap cooling surface or the back side of the anode—that are more thermally stressed.

The principle relationship in the boiling of a liquid coolant using a characteristic boiling curve is explained in the diagram of the characteristic boiling curve according to FIG. 2. This relationship is described in detail in the dissertation by Robert Goldschmidt, “Experimentelle Untersuchung des Einflusses von porös beschichteten Heizflächen auf vollständige Siedekennlinien von aufwärts strömendem Wasser im einseitig beheizten Rechteckkanal” [“Experimental testing of the influence of porous coated heating surfaces on complete characteristic boiling curves of forward-flowing water in a rectangular duct heated on one side”]. The dissertation can be obtained at edocs.tuberlin.de/diss/2004/goldschmidt_robert.pdf.

In this diagram (shown in a logarithmic depiction) the heating ΔT of the wall of the vacuum housing is plotted on the abscissa and the heat flux density HF is plotted on the ordinate. The curve of the characteristic boiling line is shown as a dashed line for an impressed heat flux density (for example heat discharge of the anode, i.e. thermal radiation), in contrast to which the curve of the characteristic boiling line is shown as a solid line for the predetermined wall temperature of the vacuum housing (heat transmitter).

Given the basic relationships (shown in FIG. 2) in the boiling of fluid across a “wall” (T_{w}—wall temperature of the vacuum housing, Tₛ—boiling temperature/saturation temperature of the coolant), it is assumed that the coolant flows against the wall with a temperature that is less than the boiling temperature Tₛ. Essentially the range of convection 10 and nucleate boiling 11 is technically usable since a jump of the wall temperature (temperature of the vacuum housing) to the range of film boiling 15 occurs at an even higher temperature (typically greater than 400° C. for water).

In an x-ray radiator, the curve of a characteristic boiling curve depends on the coolant that is used, the type of flow of the coolant, the thermodynamic state of the coolant, the arrangement of the x-ray tube in the radiator housing and the geometry of the vacuum housing of the x-ray tube, the properties of the material from which the vacuum housing is produced, and the condition of the surfaces facing towards the coolant (also called outer surfaces of the vacuum housing in the following).

Given slight overheating of the vacuum housing, the heat transfer ensues via free, single-phase convection 10 that—with increasing temperature difference—leads to better heat transfer coefficients and thus to a slight rise of the characteristic boiling curve. Depending on the wettability of the outer surface of the vacuum housing, after a more or less strong boiling retardation first vapor bubbles form at specific points on the outer surfaces of the vacuum housing, wherein the number of vapor bubbles and the size of the vapor bubbles grows with increasing overheating of the outer surfaces of the vacuum housing (onset of nucleate boiling, ONB). Nucleate boiling 11 begins with the detachment of the first vapor bubbles from the outer surfaces of the vacuum housing (wall overheating ΔT₁₁ at the beginning of the nucleate boiling 11). The outer surfaces of the vacuum housing are completely wetted by the coolant in this area. Due to the increased vapor production and the intensive agitation effect of the vapor bubbles coalescing with one another (coalescence: meeting and fusing of vapor bubbles), the heat flux density increases. The sharp rise of the characteristic boiling curve flattens somewhat shortly before its maximum because small vapor cushions temporarily form on the outer surfaces of the vacuum housing due to the bubble interactions. Nucleate boiling 11 or—in the case of high vapor contents (undesirable in x-ray radiators)—forced convective vaporization 12 occur in the most technical boiling processes. The maximum heat flux to be examined transferred given a wetted outer surface of the vacuum housing is limited by a change of the heat transfer mechanism, what is known as the departure from nucleate boiling 13 (wall overheating ΔT_{CHF} at critical heat flux density CHF). A subsequent worsening of the heat transfer is due to the fact that the coolant partially loses the immediate contact with the outer surface of the vacuum housing, and thus the heat is no longer transferred to the liquid phase but instead is transferred to the vaporous phase (with a lower heat conductivity).

For safety reasons, the knowledge of the critical heat flux density CHF (Critical Heat Flux) is of significant relevance in order to avoid a burnout of the outer surfaces of the vacuum housing or, respectively, an unwanted degradation of the heat transfer. This is important given system components with high heat conductivities per area unit, for example in cooling loops of x-ray radiators.

After the departure from nucleate boiling 13 (post-critical range), given a temperature impressed on the outer surface of the vacuum housing two (for the sake of simplicity) main ranges of heat transfer exist, namely the partial film boiling 13 (transition boiling) and the range of stable film boiling 15. The two main ranges of heat transfer are separated by the wall overheating ΔT₁₆ at Leidenfrost temperature 16. The vapor proportion at the outer surfaces of the vacuum housing increases with increasing temperature and the heat transfer additionally worsens, up to a wall temperature of the vacuum housing at which only vapor is present at the outer surfaces of the vacuum housing (Leidenfrost temperature 16 or minimum film boiling temperature). This range of the transition boiling 14 is the single heat transfer mechanism in which an increase of the driving temperature difference leads to a reduction of the heat flux.

Stable film boiling 15 ideally begins upon reaching the Leidenfrost temperature 16. As of this temperature the outer surfaces of the vacuum housing are covered only with a vapor film. As a result of thermal radiation, convection and heat conduction between the outer surfaces of the vacuum housing, the vapor and the cooling medium, the heat flux density increases again slightly with increasing temperature difference.

The Leidenfrost temperature 16 (minimum film boiling temperature) is of technical interest in processes in which the re-wetting of the outer surfaces of the vacuum housing with fluid, and the improvements of heat transfer that are connected with this, are important.

The Leidenfrost temperature 16 is increased via the measure according to the invention to apply an at least partial porous coating to the outer surfaces of the vacuum housing, i.e. to the surfaces facing towards the cooling medium. The re-wetting of the outer surfaces of the vacuum housing thereby begins earlier, and the heat transfer between the outer surfaces of the vacuum housing and the circulating coolant is thus improved.

When coolant at a temperature lower than the boiling temperature of the coolant flows against the cooling surface, the heat flux additionally increases. Therefore only higher heat flux densities HF as explained in the preceding are technically usable for cooling.

Although modifications and changes may be suggested by those skilled in the art, it is the intention of the inventor to embody within the patent warranted hereon all changes and modifications as reasonably and properly come within the scope of his contribution to the art.

I claim as my invention:

1. An x-ray radiator comprising:
a radiator housing containing a coolant;
and x-ray tube comprising a vacuum housing, said x-ray tube being arranged in said radiator housing with a plurality of surfaces of said vacuum housing facing said coolant; and
at least some of said surfaces facing said coolant having a porous coating facing said coolant.

2. An x-ray radiator as claimed in claim 1, wherein all of said surfaces of said vacuum housing that face said coolant have said porous coating thereon.

3. An x-ray radiator as claimed in claim 1, wherein said x-ray tube comprises an x-ray exit window comprising exit window surfaces forming at least some of said surfaces of said vacuum housing, said exit window surfaces having said porous coating thereon.

4. An x-ray radiator as claimed in claim 1, wherein said vacuum housing comprises an anode supported on a slide bearing comprising an internal slide bearing cooling tube forming one of said surfaces of said vacuum housing, said internal slide bearing cooling tube having said porous coating thereon.

5. An x-ray radiator as claimed in claim 1, wherein said x-ray tube comprises an electron trap having an electron trap cooling surface forming one of said surfaces of said vacuum housing, said electron trap cooling surface having said porous coating thereon.

6. An x-ray radiator as claimed in claim 1, wherein said x-ray tube comprises an anode having a back surface that forms one of said surfaces of said vacuum housing, said back surface of said anode having said porous coating thereon.

7. An x-ray radiator as claimed in claim 1, wherein said porous coating has a layer thickness in a range between 30 μm and 200 μm.

8. An x-ray radiator as claimed in claim 1, wherein said porous coating comprises corrosion-resistant material.

9. An x-ray radiator as claimed in claim 1, wherein said porous coating comprises metal.

10. An x-ray radiator as claimed in claim 1, wherein said porous coating comprises stainless steel.

11. An x-ray radiator as claimed in claim 1, wherein said porous coating comprises copper.

12. An x-ray radiator as claimed in claim 1, wherein said porous coating comprises titanium.
